(19) United States
(12) Patent Application Publication
(10) Pub. No.: US 2008/0270008 A1
(43) Pub. Date: Oct. 30, 2008

(54) Method and System for Adjusting Fuel Injector Signals for Alternative Fuel Type

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/109,974

(22) Filed: Apr. 25, 2008

Related U.S. Application Data
(60) Provisional application No. 60/914,408, filed on Apr. 27, 2007.

(51) Int. Cl. F02M 69/48; F02M 69/50

(52) U.S. Cl. 701/104

(57) ABSTRACT

An engine control unit is configured to provide a fuel injector pulse width signal in response to oxygen sensor output. A signal modifier is in communication with the engine control unit to generate a modified oxygen sensor output. A second fuel injector pulse width is provided in response to that modified oxygen sensor output. The second fuel injector pulse width is 25% the first. The second pulse width signal is optimized for a gasoline blend and, more particularly, to an E85 fuel blend.

### RELATED APPLICATIONS

The present application is a Continuation-in-Part of U.S. Ser. No. 60/914,408 and it claims a priority to the provisional's Apr. 27, 2007 filing date. The present application incorporates the subject matter disclosed in ('408) as if it is fully rewritten herein.

### BACKGROUND OF THE INVENTION

1. Field of the Invention

The present invention relates to systems for the controlled combusting of fuels, and, more particularly, to internal combustion engine systems configured to operate on multiple types of fuel.

2. Background of the Invention

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control, which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

However, conventional internal combustion gasoline or diesel engines are designed to operate on fuel specifications that severely limit the possibilities of using alternative fuels on a large and meaningful scale. Known alternative fuel blends diverge greatly from conventional petroleum-based fuel specifications, and thus replacing a petroleum fuel blend with an alternative fuel requires significant reconfiguration of engine systems and, more particularly, of engine ignition and fuel supply systems. Once reconfigured, the altered systems can no longer acceptably function with conventional gasoline blends. The owner or operator of a conventional automobile must choose between relying on a ubiquitous petroleum fuel, readily available through a huge well-developed fuel production and supply system, or reconfiguring his automobile to run instead on an alternative fuel, which may be difficult to obtain and have uncertain future supply and pricing characteristics. Switching back to the petroleum fuel blend, however, at some future point will result in service costs and efficiencies.

Thus, what is needed is a method or system that addresses the problems discussed above, as well as others, for example, enabling a conventional automobile to efficiently use both conventional petroleum fuel blends and alternative fuels.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system; and,

FIG. 2 illustrates portions of an automobile fuel injector system in accordance with a preferred embodiment of the present invention;

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

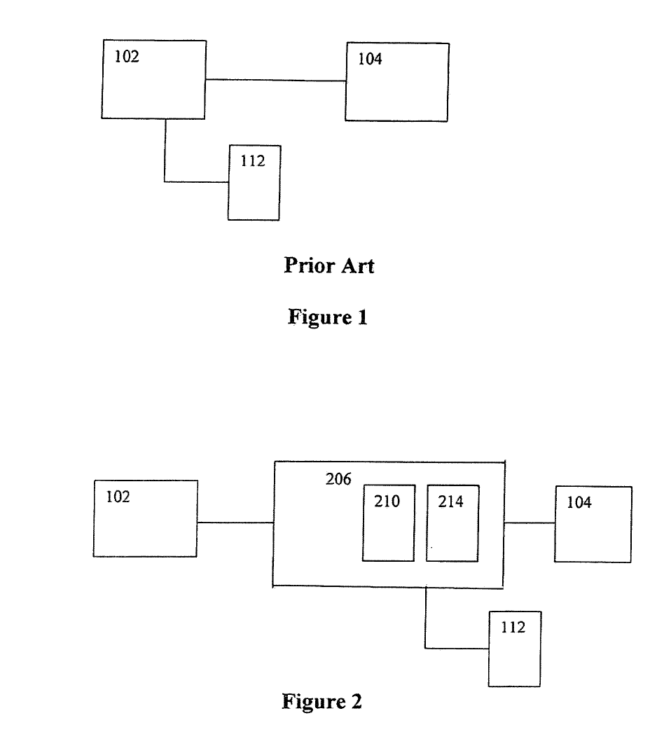

Referring now to FIG. 1, a gasoline internal combustion engine control unit (ECU) 102 is shown in communication with and configured to control a conventional automobile fuel injector component 104. The ECU 102 may also control other automobile systems, e.g., ignition timing and transmission systems (not shown). The ECU is sometimes referred to as an Engine Control Module (ECM) or a Powertrain Control Unit/Module (PCU,PCM). The fuel injector component 104 comprises a plurality of electronically controlled valves with at least one valve provided for each engine cylinder. The valves are each supplied with pressurized fuel by a fuel pump (not shown). The valves are configured to open and close many times per second. The amount of fuel supplied to the engine is determined by the amount of time the fuel injector stays open, called the “pulse width”. The length of the is controlled by pulse width signals controlled by the ECU.

The ECU 102 pulse width signals control the amount and rate of fuel injected into each engine combustion chamber, thereby controlling the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

The ECU 102 receives AFR signals from an oxygen sensor 112 located in a vehicle exhaust pipe to monitor the amount of oxygen in the exhaust. The ECU 102 uses one or more formula(s) and a large number of lookup tables to determine an appropriate pulse width for a given operating condition, avoiding too-rich and too-lean AFRs by increasing or decreasing fuel injector 104 pulse widths in real-time in a closed-loop control system. The ECU 102 generally computes more than 100 parameters, each having its own lookup table, and some of the parameters even change over time in order to compensate for changes in the performance of engine components, s.a., e.g., a catalytic converter. Depending on tile engine speed, the ECU 102 performs these calculations over a hundred times per second.

Problems arise if the ECU 102 is used with alternative fuels. For example, E85 fuel combustion generates lower energy as measured in British Thermal Units (BTUs) than gasoline fuel blends, and thus higher pulse widths are required to generate comparable engine performances under similar operating parameters. And reconfiguring the ECU 102 to produce appropriate pulse width signals for more than one anticipated fuel blend is not practical in view of the complex computational demands placed upon the limited available ECU 102 processor resources for even one fuel type.

FIG. 2 provides an alternative fuel injector control system according to the present invention, wherein a Pulse Modifier 206 is provided interposed between the ECU 102 and the vehicle oxygen sensor 112. The simulator 206 modifies the vehicle oxygen sensor 112 signals to cause the ECU 102 to widen or to narrow the pulse width signals in order to enable the fuel injectors 104 to efficiently operate on a specified alternative fuel. The Simulator 206 may be programmed or otherwise configured by a manufacturer, an after-market retailer or installer, or by some other service provider. It may also be subsequently re-programmed as required to provide optimal fuel injector settings for one or more specified alternative fuels.

In one embodiment for a conventional automobile configured to use gasoline fuel blends, the Simulator 206 enables the use of E85 fuel by modifying the vehicle oxygen sensor 112 signals to present a “too lean” input to the ECU 102. In effect, the ECU 102 is tricked into thinking the engine is running lean (less fuel than air). The ECU 102 compensates for this lean condition by increasing the pulse width outputs to the fuel injectors 104. It is preferred pulse width is increased approximately 27%, thus increasing an amount of fuel pumped into the fuel injectors.

The vehicle oxygen sensor 112 output to the ECU 102 is typically a voltage output signal that ranges from zero-to-one, with low voltage values indicating a correspondingly lean AFR and high voltage values indicating a correspondingly rich AFR. In some embodiments, the Simulator 206 comprises a resistor-divider network circuit 210 or an op-amp circuit 210 that decreases the vehicle oxygen sensor 112 output voltages by about 27%. In other embodiments, a processor component 210, s.a., a microprocessor component, applies one or more algorithms to the vehicle oxygen sensor 112 output signal and sends a modified signal to the ECU 102.

In some examples, the Simulator 206 also comprises a switch 214 that toggles the Simulator 206 into active or inactive states. When the inactive state is selected, the vehicle oxygen sensor 112 outputs are passed unmodified to the ECU 102. The switch 214 thus enables use of a conventional fuel, as well as at least one alternative fuel, by activating the Simulator 206 to modify pulse widths when toggled into an active state. The switch 214 may be manually operated by a user, or it may be configured to detect a fuel type being used and selected between active and inactive states, accordingly.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Having thus described the invention what is claimed as new and desired to be secured by Letters Patent is as follows:

1. A system, comprising:
an engine control unit configured to provide a fuel injector pulse width signal having a first width in response to an oxygen sensor output;
a signal modifier in communication with the engine control unit and an oxygen sensor, the signal modifier is configured to modify the oxygen sensor output to generate a modified oxygen sensor output to the engine control unit, wherein the engine control unit is configured to provide a fuel injector pulse width signal having a second width in response to the modified oxygen sensor output; and,
a fuel injector component in communication with the engine control unit fuel injector pulse width signal;
wherein the first and the second pulse widths are different.

2. The system of claim 1, wherein the pulse width signal is optimized for a gasoline blend, and wherein the second pulse width signal is optimized for an E85 fuel blend.

3. The system of claim 1, wherein the second pulse width is about 25% greater than the first pulse width.

4. A method, comprising the steps of:
generating a, first pulse width signal optimized for a first fuel, in response to an oxygen sensor output signal;
modifying the oxygen sensor output signal;
generating a second pulse width signal optimized for an alternative fuel in response to the modifying oxygen sensor output signal;
providing the first pulse width to a fuel injector if a first fuel is selected; and,
providing the second pulse width to the fuel injector if the alternate fuel is selected.

5. The method of claim 4, further comprising the steps of:
optimizing the first pulse width signal for a gasoline blend; and,
optimizing the second pulse width signal for an E85 fuel blend.

6. The method of claim 5, wherein the step of optimizing the second pulse width signal comprises widening the first pulse width signal by a widening factor.

7. The method of claim 6, wherein the widening factor is about 27%.
